(19) United States
(12) Patent Application Publication
(10) Pub. No.: US 2024/0220814 A1
(43) Pub. Date: Jul. 4, 2024

(54) TRAINING DEVICE, TRAINING METHOD AND TRAINING PROGRAM

(71) Applicant: NIPPON TELEGRAPH AND TELEPHONE CORPORATION, Tokyo (JP)

(72) Inventors: Shinya YAMAGUCHI, Musashino-shi, Tokyo (JP); Sekitoshi KANAI, Musashino-shi, Tokyo (JP)

(73) Assignee: NIPPON TELEGRAPH AND TELEPHONE CORPORATION, Tokyo (JP)

(21) Appl. No.: 18/563,400

(22) PCT Filed: May 27, 2021
(86) PCT No.: PCT/JP2021/020306

§ 371 Date: Nov. 22, 2023

(51) Int. Cl. G06N 3/094; G06N 3/045

(52) U.S. Cl. CPC G06N 3/094; G06N 3/045

(57) ABSTRACT

The removal unit removes a predetermined component from a frequency component obtained by transforming data of a predetermined domain. The calculation unit calculates a loss function on the basis of a result obtained by inputting data obtained by returning a frequency component, from which a predetermined component has been removed by the removal unit, to a predetermined domain into a discriminator constituting an adversarial learning model. The update unit updates the parameter of the adversarial learning model so that the loss function is optimized.

### TECHNICAL FIELD

The present invention relates to a learning device, a learning method, and a learning program.

### BACKGROUND ART

Conventionally, a deep generation model that is a technique based on a deep learning technique and generates a sample close to a real thing by learning a distribution of learned data is known. For example, a generative adversarial network (GAN) is known as a deep generation model (e.g., refer to Non Patent Literature 1).

Moreover, for example, variational auto encoders (VAEs) (Reference Literature 1: Kingma, Diederik P., and Max Welling. “Auto-encoding variational bayes.” arXiv preprint arXiv: 1312.6114 (2013). (ICLR 2014)) are known as other deep generation models.

### CITATION LIST

### Non Patent Literature

Non Patent Literature 1: Goodfellow, Ian, et al. “Generative adversarial nets.” Advances in neural information processing systems. 2014. (NIPS 2014)

### SUMMARY OF INVENTION

### Technical Problem

However, conventional techniques have a problem that over-learning may occur and the accuracy of the model may not be improved. For example, a high frequency component not included in actual learning data is mixed into a sample generated by a generator of a learned GAN. As a result, a discriminator performs authenticity determination depending on a high frequency component, and over-learning may occur.

### Solution to Problem

In order to solve the above-described problem and achieve an object, a learning device includes: a removal unit configured to remove a predetermined component from a frequency component obtained by transforming data of a predetermined domain; a calculation unit configured to calculate a loss function on the basis of a result obtained by inputting data obtained by returning the frequency component, from which the predetermined component has been removed by the removal unit, to the predetermined domain into a discriminator constituting an adversarial learning model; and an update unit configured to update a parameter of the adversarial learning model so that the loss function is optimized.

### Advantageous Effects of Invention

According to the present invention, the occurrence of over-learning can be suppressed, and the accuracy of the model can be improved.

### BRIEF DESCRIPTION OF DRAWINGS

FIG. 1 is a diagram for explaining a deep learning model according to a first embodiment.

FIG. 2 is a diagram for explaining an influence of a high frequency component.

FIG. 3 is a diagram illustrating a configuration example of a learning device according to the first embodiment.

FIG. 4 is a diagram for explaining a method of removing a high frequency component.

FIG. 5 is a diagram illustrating an example of a component to be removed.

FIG. 6 is a flowchart illustrating a flow of processing of a learning device according to the first embodiment.

FIG. 7 is a flowchart illustrating a flow of processing of a learning device according to a second embodiment.

FIG. 8 is a diagram illustrating an experimental result.

FIG. 9 is a diagram illustrating an experimental result.

FIG. 10 is a diagram illustrating an experimental result.

FIG. 11 is a diagram illustrating an application example of a filter for removing a high frequency component.

FIG. 12 is a diagram illustrating an example of a computer that executes a learning program.

### DESCRIPTION OF EMBODIMENTS

Hereinafter, embodiments of a learning device, a learning method, and a learning program according to the present application will be described in detail with reference to the drawings. Note that the present invention is not limited to the embodiments described below.

A GAN is a technique of learning a data distribution p_data(x) using two deep learning models of a generator G and a discriminator D. The G learns to deceive the D, and the D learns to distinguish the G from learning data. A model in which a plurality of such models has an adversarial relationship may be referred to as an adversarial learning model.

An adversarial learning model such as the GAN is used in generation of images, texts, voices, and the like.

Here, the GAN has a problem that the D over-learns a learning sample as the learning progresses. As a result, each model cannot perform meaningful update to data generation, and the generation quality of the generator deteriorates.

Moreover, Reference Literature 2 describes that a learned CNN output performs prediction depending on a high frequency component of an input.

Reference Literature 2: Wang, Haohan, et al. “High-frequency Component Helps Explain the Generalization of Convolutional Neural Networks.” Proceedings of the IEEE/CVF Conference on Computer Vision and Pattern Recognition. 2020. (CVPR 2020)

### First Embodiment

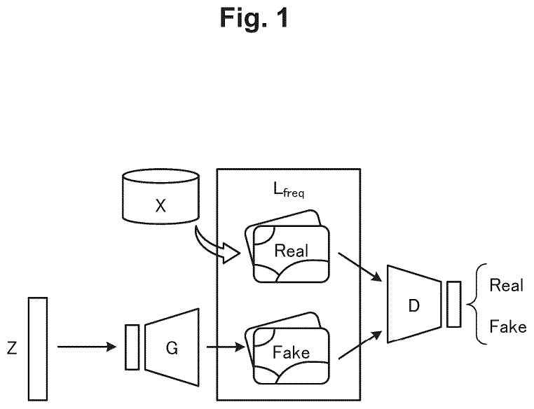

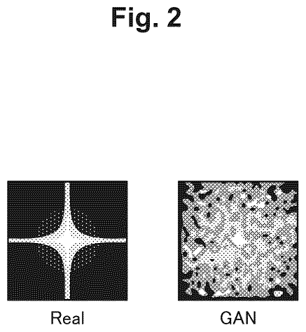

Therefore, an object of the first embodiment is to suppress the occurrence of over-learning and improve the accuracy of the model by removing the high frequency component of the data inputted into the discriminator D. FIG. 1 is a diagram for explaining a deep learning model according to the first embodiment. Moreover, FIG. 2 is a diagram for explaining an influence of a high frequency component.

As illustrated in FIG. 2, CIFAR-10 (two-dimensional power spectrum) is different between real data (Real) and data (Fake) generated by the generator. Moreover, Reference Literature 3 shows that data generated by various GANs has an increased power spectrum at a high frequency as compared with real data.

Reference Literature 3: Durall, Ricard, Margret Keuper, and Janis Keuper. “Watch your Up-Convolution: CNN Based Generative Deep Neural Networks are Failing to Reproduce Spectral Distributions.” Proceedings of the IEEE/CVF Conference on Computer Vision and Pattern Recognition. 2020. (CVPR 2020)

Returning to FIG. 1, in a deep learning model of the present embodiment, the discriminator D discriminates which data is Real (or Fake) regarding data (Real) included in a real data set X and data (Fake) generated by the generator G from a random number z.

In the GAN, the discriminator D is optimized so that the discrimination accuracy of the discriminator D is improved, that is, the probability that the discriminator D discriminates Real as Real increases. Moreover, the generator G is optimized so that the ability of the generator G to deceive the generator G, that is, the probability that the discriminator D discriminates Real as Fake increases.

In addition to the above optimization, the generator G is optimized so that frequency components of Real and Fake match in the present embodiments. The following description will explain details of learning processing of the deep learning model in addition to a configuration of a learning device of the embodiments.

### Configuration of First Embodiment

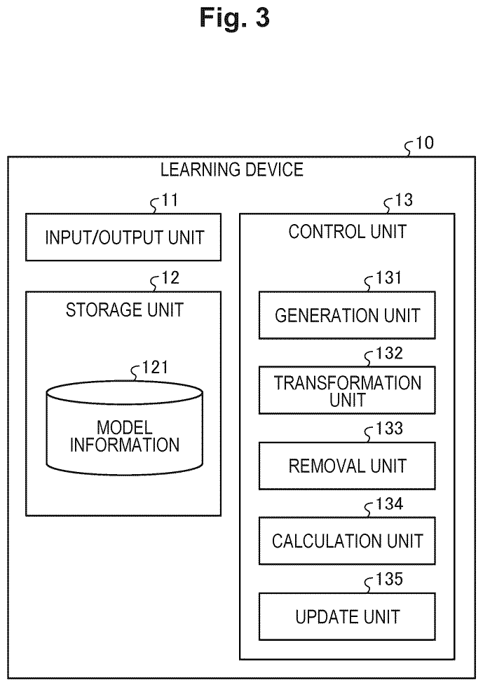

FIG. 3 is a diagram illustrating a configuration example of a learning device according to the first embodiment. A learning device 10 accepts an input of learning data and updates a parameter of a deep learning model. Moreover, the learning device 10 may output an updated parameter. As illustrated in FIG. 3, the learning device 10 includes an input/output unit 11, a storage unit 12, and a control unit 13.

The input/output unit 11 is an interface for inputting/outputting data. For example, the input/output unit 11 may be a communication interface such as a network interface card (NIC) for performing data communication with another device via a network. Moreover, the input/output unit 11 may be an interface to be connected with an input device such as a mouse or a keyboard, and an output device such as a display.

The storage unit 12 is a storage device such as a hard disk drive (HDD), a solid state drive (SSD), or an optical disk. Note that the storage unit 12 may be a data-rewritable semiconductor memory such as a random access memory (RAM), a flash memory, or a non volatile static random access memory (NVSRAM). The storage unit 12 stores an operating system (OS) and various programs to be executed by the learning device 10. Moreover, the storage unit 12 stores model information 121.

The model information 121 is information such as parameters for constructing a deep learning model, and is appropriately updated in the learning processing. Moreover, the updated model information 121 may be outputted to another device or the like via the input/output unit 11.

The control unit 13 controls the entire learning device 10. The control unit 13 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA). Moreover, the control unit 13 has an internal memory for storing programs defining various processing procedures and control data, and executes each processing using the internal memory. Moreover, the control unit 13 functions as various processing units by operation of various programs. For example, the control unit 13 includes a generation unit 131, a transformation unit 132, a removal unit 133, a calculation unit 134, and an update unit 135.

The generation unit 131 inputs the random number z into the generator G to generate data.

The transformation unit 132 transforms data inputted into the discriminator D into frequency components. The transformation unit 132 transforms real data (Real) and data (Fake) generated by the generator into frequency components.

The removal unit 133 removes a predetermined component from a frequency component obtained by transforming data of a predetermined domain. In the embodiment, the removal unit 133 removes a high frequency component.

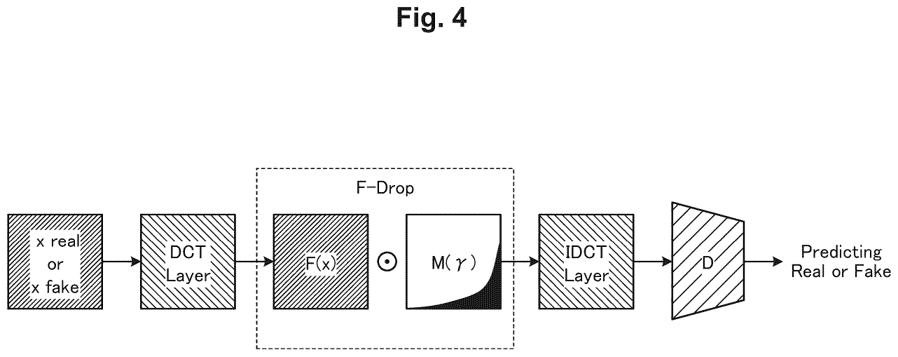

Here, processing of removing a high frequency component by the transformation unit 132 and the removal unit 133 will be described with reference to FIG. 4. FIG. 4 is a diagram illustrating a method of removing a high frequency component.

As illustrated in FIG. 4, in the DCT Layer, the transformation unit 132 transforms xᵣₑₐₗ and x_{fake} into frequency components by discrete Fourier transform (DET) or discrete cosine transform (DCT).

The xᵣₑₐₗ is real data, and is referred to as first data herein. Moreover, the x_{fake} is data generated by the generator, and is referred to as second data herein. Moreover, the transformation unit 132 transforms the first data into a first frequency component and transforms the second data into a second frequency component.

Next, the removal unit 133 removes (filtering, masking) the high frequency component by Formula (1) in F-Drop. The x is one of the first data xᵣₑₐₗ and the second data x_{fake}. F(⋅) is a function for performing frequency transformation by DFT and DCT.

$$[ Math . 1 ]$$

$$Drop ( x , y ) = {ℱ}^{- 1} ( ℱ ( x ) {ℱ}^{- 1} ⊙ M ( γ ) ) \qquad ( 1 )$$

However, each component of the function M is calculated by Formula (2).

$$[ Math . 2 ]$$

$${M}_{u , v}^{c} ( γ ) = \{ \begin{matrix}1 ( \sqrt{{u}^{2} + {v}^{2}} \leq γ \sqrt{{H}^{2} + {W}^{2}} ) \\ 0 ( \sqrt{{u}^{2} + {v}^{2}} > γ \sqrt{{H}^{2} + {W}^{2}} )\end{matrix} \} \qquad ( 2 )$$

Here, each data in the frequency space (frequency domain) is represented by coordinates on the u axis and the v axis. Moreover, the right side of the inequality of Formula (2) is determined according to the data.

For example, in a case where the first data and the second data are image data, H is a height of the image, and W is a width of the image. The height H and the width W are represented by, for example, the number of pixels. Moreover, in this case, the image data before transformation is data in an RGB space in which each element is represented by an RGB value.

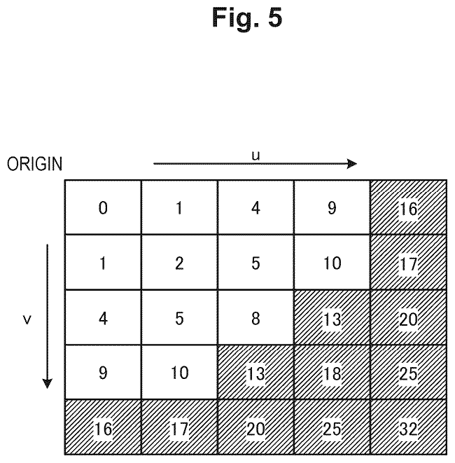

Here, when the size of the image data is 5×5, the components illustrated in FIG. 5 are removed by Formula (1). FIG. 5 is a diagram illustrating an example of a component to be removed. Here, it is assumed that the parameter satisfies γ=0.5. In this case, the right side of the inequality of Formula (2) corresponding to the threshold is 0.5×(5²+5²)^{1/2}. Therefore, the square of the threshold is 12.5.

The numerical value in each cell in FIG. 5 is a value obtained by squaring the left side of the inequality of Formula (2). For example, in a case where (u, v)=(0, 0) is satisfied, ((u²+v²)^{1/2})²=0, which is equal to or less than the threshold 12.5, is not removed. On the other hand, in a case where (u, v)=(2, 3) is satisfied, ((u²+v²)^{1/2})²=13, which is larger than the threshold 12.5, is removed.

It can be said that (u²+v²)^{1/2} indicates a distance from the origin in the frequency space. Therefore, the removal unit 133 removes a component whose distance from the origin in the frequency domain is equal to or longer than a threshold from the first frequency component obtained by transforming the first image data in the RGB space and from the second frequency component obtained by transforming the second image data in the RGB space generated by the generator constituting the adversarial learning model.

Furthermore, the transformation unit 132 returns the data, from which a component has been removed by the removal unit 133, to the space before transformation. For example, when transformation by discrete cosine transform (DCT) is performed, the transformation unit 132 performs inverse transformation by inverse discrete cosine transform (IDCT).

In a case where the original data is image data in the RGB space, the transformation unit 132 transforms data in the frequency space, from which a high frequency component of Formula (1) has been removed, into data in the RGB space by inverse transformation.

In this manner, the removal unit 133 removes a predetermined component from the first frequency component obtained by transforming the first data and from the second frequency component obtained by transforming the second data generated by the generator constituting the adversarial learning model.

The calculation unit 134 calculates a loss function on the basis of a result obtained by inputting data obtained by returning the frequency component, from which the predetermined component has been removed by the removal unit 133, to a predetermined domain into the discriminator constituting the adversarial learning model.

The calculation unit 134 calculates a loss function that becomes larger as the discrimination accuracy of the discriminator becomes lower for each of data whose first frequency component and second frequency component, from which the predetermined component has been removed, are returned to the predetermined domain.

The update unit 135 updates a parameter of the adversarial learning model so that the loss function is optimized. For example, the update unit 135 updates a parameter of the generator so that the loss function is optimized.

For example, the calculation unit 134 and the update unit 135 update the parameter using a loss function used in a known adversarial learning model (GAN).

### Processing of First Embodiment

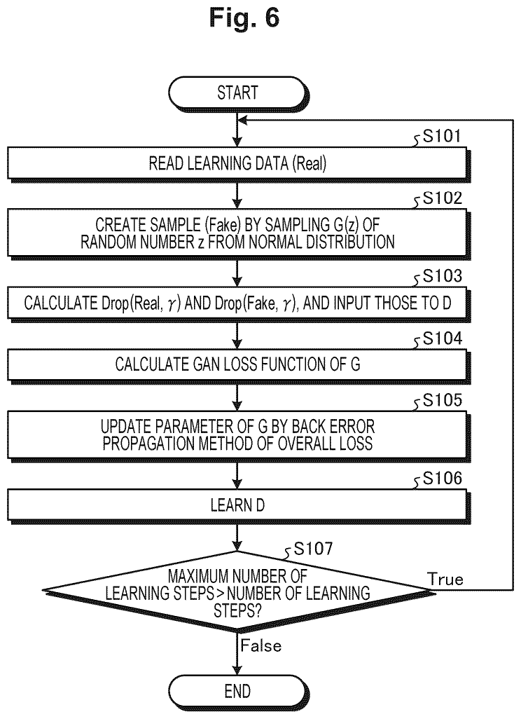

FIG. 6 is a flowchart illustrating a flow of processing of the learning device according to the first embodiment. As illustrated in FIG. 6, the learning device 10 first reads learning data (step S101). Here, the learning device 10 reads real data (Real) as learning data.

Next, the learning device 10 samples a random number z from a normal distribution, and creates a sample (Fake) by G(z) (step S102).

Here, the learning device 10 calculates Drop(Real, γ) and Drop(Fake, γ), and inputs the results into the discriminator D (step S103). The function Drop(⋅) is as described in Formula (1).

Here, the learning device 10 calculates a GAN loss function of the generator G (step S104).

Furthermore, the learning device 10 updates the parameter of the generator G by the back error propagation method of the overall loss (here, a GAN loss function) (step S105).

Moreover, the learning device 10 learns the discriminator D (step S106).

At this time, in a case where the maximum number of learning steps>the number of learning steps is satisfied (step S107, True), the learning device 10 returns to step S101 and repeats the processing. On the other hand, in a case where the maximum number of learning steps>the number of learning steps is not satisfied (step S107, False), the learning device 10 terminates the processing.

### Effects of First Embodiment

As described above, the removal unit 133 removes a predetermined component from the frequency component obtained by transforming the data of the predetermined domain. The calculation unit 134 calculates a loss function on the basis of a result obtained by inputting data obtained by returning the frequency component, from which the predetermined component has been removed by the removal unit 133, to a predetermined domain into the discriminator constituting the adversarial learning model. The update unit 135 updates a parameter of the adversarial learning model so that the loss function is optimized.

As described above, the generator G and the discriminator D in the GAN may be excessively concentrated on the high frequency component of the data, and over-learning may occur. For example, when the discriminator D performs authenticity determination depending on the high frequency component, the generator G learns the high frequency component to deceive the discriminator D. Then, the result of the authenticity determination depends only on the high frequency component, and effective update for bringing the data distribution closer is not performed.

On the other hand, the learning device 10 can remove the high frequency component (frequency drop) and perform learning of the GAN after removing the high frequency component.

As a result, according to the present embodiment, it is possible to suppress the deviation (frequency gap) of the frequency component from the learning data generated in learning of the GAN. Furthermore, the data generation quality of the generator G is also improved as the property in the frequency component becomes closer.

As described above, according to the present embodiment, the occurrence of over-learning can be suppressed, and the accuracy of the model can be improved.

The removal unit 133 removes a predetermined component from the first frequency component obtained by transforming the first data and from the second frequency component obtained by transforming the second data generated by the generator constituting the adversarial learning model. The calculation unit 134 calculates a loss function that becomes larger as the discrimination accuracy of the discriminator becomes lower for each of data whose first frequency component and second frequency component, from which the predetermined component has been removed, are returned to the predetermined domain. The update unit 135 updates the parameter of the generator so that the loss function is optimized.

As described above, it is possible to further improve the accuracy of the model by removing the high frequency component from both the real data and the generated data in the GAN.

The removal unit 133 removes a component whose distance from the origin in the frequency domain is equal to or longer than a threshold from the first frequency component obtained by transforming the first image data in the RGB space and from the second frequency component obtained by transforming the second image data in the RGB space generated by the generator constituting the adversarial learning model.

As a result, according to the embodiment, the high frequency component can be removed from the image data.

### Second Embodiment

The learning device 10 may cause the loss function to include the frequency component matching loss of the generator G and the discriminator D. In the second embodiment, the learning device 10 optimizes the frequency component matching loss at the time of learning.

The processing of the generation unit 131 and the transformation unit 132 is similar to that of the first embodiment.

The calculation unit 134 further calculates an inter-data error between the first frequency component and the second frequency component. The calculation unit 134 can calculate the error by an arbitrary method such as the mean square error (MSE), the root mean square error (RMSE), or L1. Here, the calculation unit 134 calculates L_{D} in Formula (3) and L_{G} in Formula (4). Moreover, the calculation unit 134 calculates the inter-data error L_{freq} (frequency component matching loss) by Formula (5).

$$[ Math . 3 ]$$

$${ℒ}_{D} = - {𝔼}_{x ∼ {p}_{data}} log D ( x ) - {𝔼}_{z ∼ {p}_{z}} log ( 1 - D ( G ( z ) ) ) \qquad ( 3 )$$

$$[ Math . 4 ]$$

$${ℒ}_{G} = - {𝔼}_{z ∼ {p}_{z}} log D ( G ( z ) ) + λ {ℒ}_{freq} \qquad ( 4 )$$

$$[ Math . 5 ]$$

$${ℒ}_{freq} = {‖ \frac{1}{\vert {X}_{real} \vert} {\sum }_{i} F ( {x}_{i}^{real} ) - \frac{1}{\vert {X}_{fake} \vert} {\sum }_{j} F ( {x}_{j}^{fake} ) ‖}^{2} \qquad ( 5 )$$

Here, Xᵣₑₐₗ and X_{fake} are batches of Real and Fake, respectively. Moreover, |Xᵣₑₐₗ| and |X_{fake}| are batch sizes thereof, respectively. Real is real data. Moreover, Fake is data generated by the generator G.

Moreover, F(⋅) is a function that transforms data in a spatial domain into a frequency component. The x^{real}ᵢ and the x^{fake}ⱼ are i-th data of Xᵣₑₐₗ and j-th data of X_{fake}, respectively, and are examples of the first data and the second data. Moreover, F(x^{real}ᵢ) corresponds to the first frequency component. Moreover, F(x^{fake}ⱼ) corresponds to the second frequency component.

In this manner, the calculation unit 134 calculates an error between a batch average of the plurality of first frequency components obtained by transforming the plurality of first data and a batch average of the plurality of second frequency components obtained by transforming the plurality of second data. That is, the error here corresponds not to an error between single data samples but to an error between batch averages.

Furthermore, the calculation unit 134 calculates a loss function L_{G} that becomes larger as the error between the first frequency component and the second frequency component becomes larger and that becomes larger as the accuracy of discrimination of the first data and the second data by the discriminator constituting the adversarial learning model becomes lower as in Formula (4). The λ is a hyperparameter that functions as a weight.

The G(⋅) is a function that outputs data (Fake) generated by the generator G on the basis of an argument. Moreover, D(⋅) is a function that outputs a probability that the discriminator D discriminates data inputted as an argument as Real.

The update unit 135 updates the parameter of the adversarial learning model so that both the loss function and the inter-data error are optimized. Specifically, the update unit 135 updates the parameter of the generator G so that the loss function L_{G} in Formula (4) is optimized.

Moreover, the update unit 135 updates the parameter of the discriminator D so that the loss function L_{D} of Formula (3) is optimized. Here, x is real data (Real).

### Processing of Second Embodiment

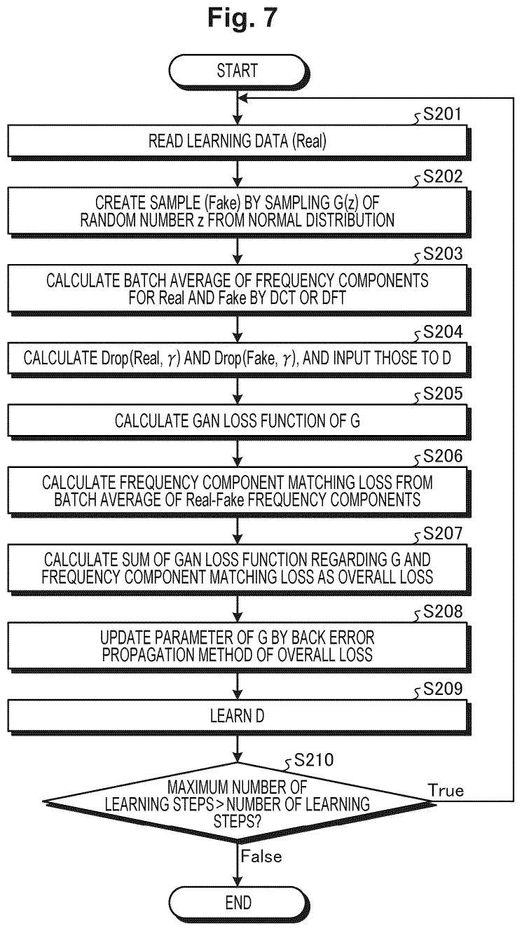

FIG. 7 is a flowchart illustrating a flow of processing of a learning device according to the second embodiment. As illustrated in FIG. 7, the learning device 10 first reads learning data (step S201). Here, the learning device 10 reads real data (Real) as learning data.

Next, the learning device 10 samples a random number z from a normal distribution, and generates a sample (Fake) by G(z) (step S202). Moreover, the learning device 10 transforms Real and Fake into frequency components by DCT or DFT, and then calculates the batch average of the frequency components (step S203).

Here, the learning device 10 calculates Drop(Real, γ) and Drop(Fake, γ), and inputs the results into the discriminator D (step S204). The function Drop(⋅) is as described in Formula (1).

The learning device 10 calculates a GAN loss function of the generator G (step S205). The GAN loss of the generator G corresponds to a first term on the right side of Formula (4). Then, the learning device 10 calculates a frequency component matching loss from the batch average of the Real-Fake frequency components (step S206). The frequency component matching loss corresponds to L_{freq} in Formula (5).

Furthermore, the learning device 10 calculates the sum of the GAN loss function regarding G and the frequency component matching loss as an overall loss (step S207). The overall loss corresponds to L_{G} in Formula (4). The learning device 10 may multiply the frequency component matching loss by weight λ. The learning device 10 updates the parameter of the generator G by the back error propagation method of the overall loss (step S208).

Moreover, the learning device 10 learns the discriminator D (step S209). Specifically, the learning device 10 updates the parameter of the discriminator D by the back error propagation method of the loss function L_{D} of Formula (3).

At this time, in a case where the maximum number of learning steps>the number of learning steps is satisfied (Step S210, True), the learning device 10 returns to step S101 and repeats the processing. On the other hand, in a case where the maximum number of learning steps>the number of learning steps is not satisfied (Step S210, False), the learning device 10 terminates the processing.

### Effects of Second Embodiment

The calculation unit 134 further calculates an inter-data error between the first frequency component and the second frequency component. The update unit 135 updates the parameter of the adversarial learning model so that both the loss function and the inter-data error are optimized.

As a result, the influence of the frequency component in learning of the adversarial learning model can be further reduced.

[Experiment]

An experiment for actually carrying out the above embodiment will be described. The experimental settings are as follows.

### Experimental Settings

Data sets (image): CIFAR-10, CIFAR-100, TinyImageNet, STL-10, CelebA, ImageNet
   CIFAR-10/-100: 50,000
   TinyImageNet, STL-10: 100,000
   CelebA: 200,000
   ImageNet: 1300,000
Neural network architecture: ResNet-SNGAN

### Experimental Procedure

100,000 iteration of learning using learning data
Measure generation quality FID for each 1,000 iteration
Set model with highest FID score as final model
The test was carried out 10 times in total, and evaluation was performed according to the following indices.
Frequency gap: difference between frequency component of learning data and frequency component of generated data
FID (Reference Literature 4)/KID (Reference Literature 5)/IS (Reference Literature 6): Scale representing quality of generated image

### Experimental Pattern

SNGAN: Baseline (normal GAN) (Reference Literature 7)
Binomial: Existing method 1: Add a low-pass filter to the generator (Reference Literature 8)
SR: Existing method 2: Minimize the frequency component difference between the generated image and the learning image (using one-dimensional DFT, binary cross-entropy) (Reference Literature 3)
SSD-GAN: Existing method 3: Add a frequency discriminator to the discriminator (Reference Literature 9)
F-Drop: First embodiment
F-Match: Calculate the matching loss and do not perform frequency drop in the second embodiment
F-Drop&Match: Second embodiment
Reference Literature 4: Heusel, Martin, et al. “Gans trained by a two time-scale update rule converge to a local nash equilibrium.” Advances in neural information processing systems. 2017. (NeurIPS 2017)
Reference Literature 5: Binkowski, Mikolaj, et al. “Demystifying mmd gans.” arXiv preprint arXiv: 1801.01401 (ICLR 2018).
Reference Literature 6: Salimans, Tim, et al. “Improved techniques for training gans.” arXiv preprint arXiv: 1606.03498 (NeurIPS 2016).
Reference Literature 7: Miyato, Takeru, et al. “Spectral normalization for generative adversarial networks.” arXiv preprint arXiv: 1802.05957 (ICLR 2018).
Reference Literature 8: Frank, Joel, et al. “Leveraging frequency analysis for deep fake image recognition.” International Conference on Machine Learning. PMLR, 2020.
Reference Literature 9: Chen, Yuanqi, et al. “SSD-GAN: Measuring the Realness in the Spatial and Spectral Domains.” arXiv preprint arXiv: 2012.05535 (AAAI 2021)

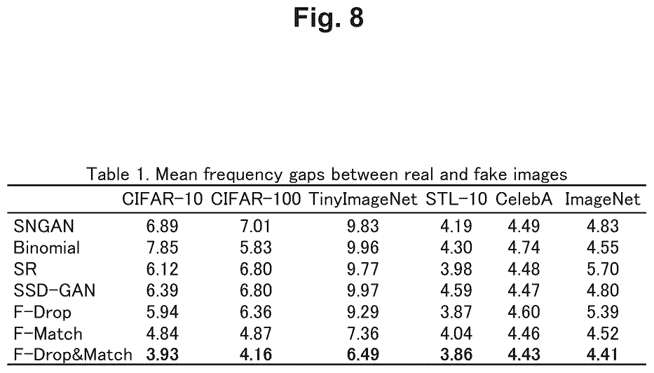

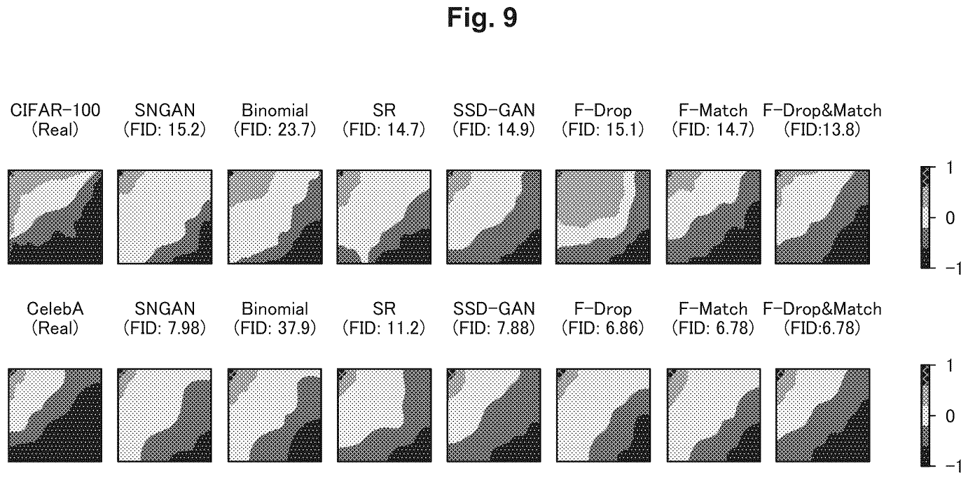

FIGS. 8 and 9 are diagrams illustrating experimental results. FIG. 8 is an average of the absolute errors of the frequency components. FIG. 9 is a visualization of the DCT coefficients of the respective frequency components. As illustrated in FIGS. 8 and 9, it can be said that the frequency gap can be reduced by the first embodiment (F-Drop) and the second embodiment (F-Drop & Match). It can be confirmed from FIG. 9 that particularly the second embodiment has a frequency component close to real data (Real).

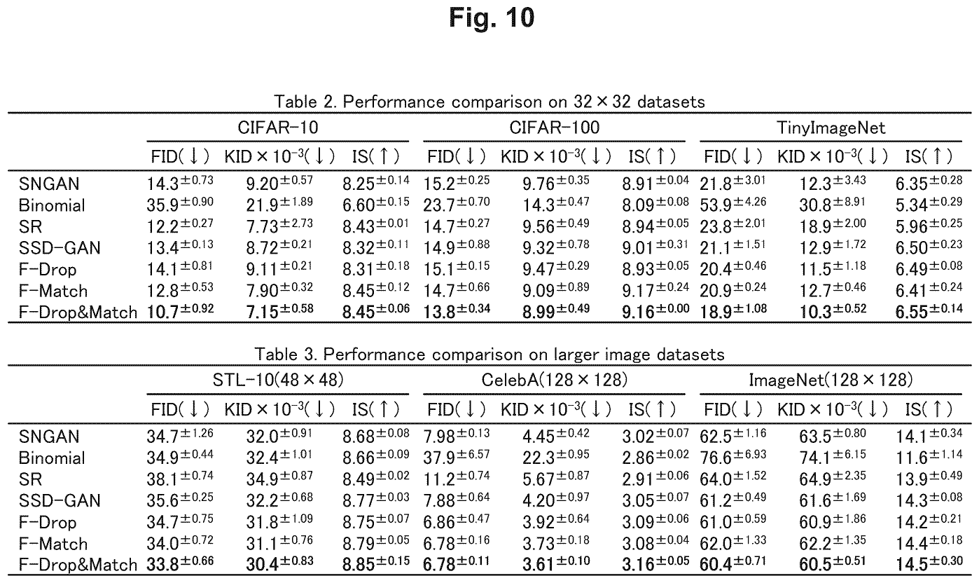

FIG. 10 is a diagram illustrating an experimental result. It can be said from FIG. 10 that the generation quality of the generator G is improved by the first embodiment and the second embodiment.

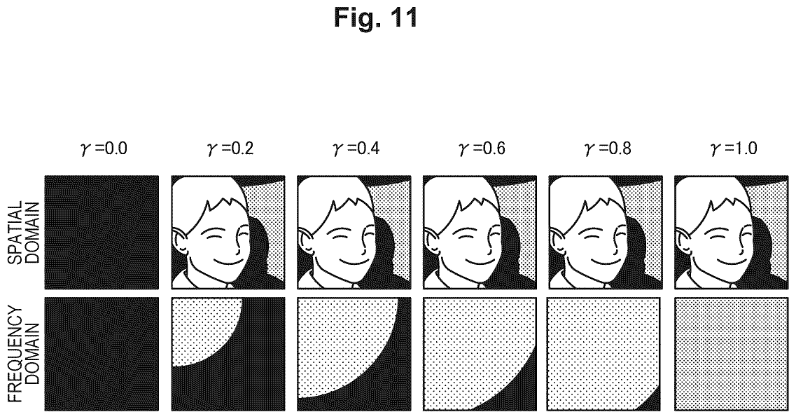

FIG. 11 is a diagram illustrating an application example of a filter for removing a high frequency component. The γ is a parameter of an argument of the function M. As illustrated in FIG. 9, in a case where the frequency is removed, the frequency domain is influenced, though the spatial domain is not influenced.

In this way, the high frequency component does not influence the appearance of an image for humans. This is because natural images recognized by humans are concentrated on low frequency components.

### [System Configuration and the Like]

Moreover, each component of each illustrated device is functionally conceptual, and does not necessarily need to be physically configured as illustrated. That is, a specific form of distribution and integration of devices is not limited to the illustrated form, and all or some thereof can be functionally or physically distributed or integrated in an arbitrary unit according to various loads, usage conditions, and the like. The whole or an arbitrary part of each processing function performed in each device can be implemented by a central processing unit (CPU) and a program analyzed and executed by the CPU, or may be implemented as hardware by wired logic. Moreover, the program may be executed not only by a CPU but also by another processor such as a GPU.

Moreover, among the processes described in the present embodiment, all or some of the processes described as being automatically performed can be manually performed, or all or some of the processes described as being manually performed can be automatically performed by a known method. In addition, the processing procedure, the control procedure, specific names, and information including various data and parameters illustrated in the literatures and the drawings can be arbitrarily changed unless otherwise specified.

### [Program]

As an embodiment, the learning device 10 can be mounted by installing a learning program for executing the above learning processing as package software or online software in a desired computer. For example, it is possible to cause an information processing device to function as the learning device 10 by causing the information processing device to execute the above learning program. The information processing device mentioned here includes a desktop or notebook personal computer. In addition, the information processing device includes a mobile communication terminal such as a smartphone, a mobile phone, and a personal handyphone system (PHS), a slate terminal such as a personal digital assistant (PDA), and the like.

Moreover, the learning device 10 can also be mounted as a learning server device that uses a terminal device used by the user as a client and provides the client with a service related to the learning processing described above. For example, the learning server device is mounted as a server device that provides a learning service having learning data as an input and information of a learned model as an output. In this case, the learning server device may be mounted as a web server, or may be mounted as a cloud that provides a service related to the learning processing by outsourcing.

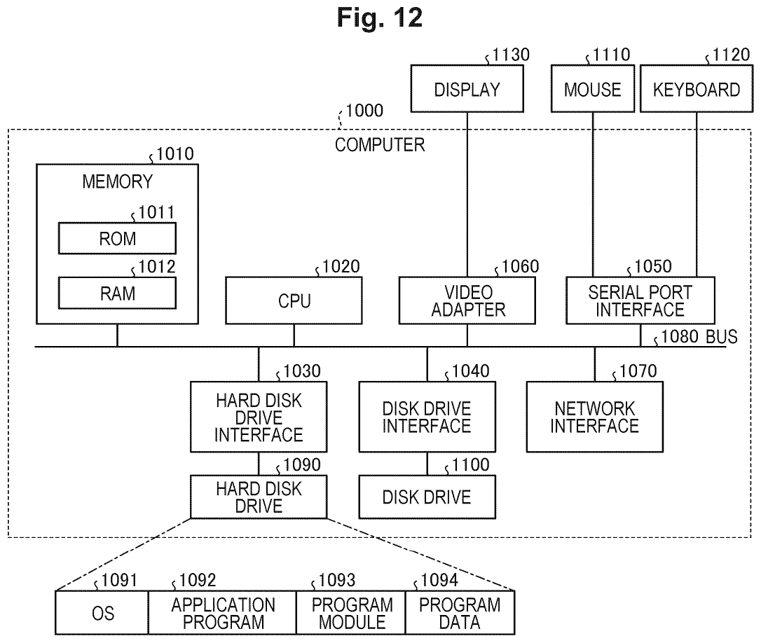

FIG. 12 is a diagram illustrating an example of a computer that executes the learning program. A computer 1000 includes, for example, a memory 1010 and a CPU 1020. Moreover, the computer 1000 also includes a hard disk drive interface 1030, a disk drive interface 1040, a serial port interface 1050, a video adapter 1060, and a network interface 1070. These units are connected with each other by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected with a hard disk drive 1090. The disk drive interface 1040 is connected with a disk drive 1100. For example, a removable storage medium such as a magnetic disk or an optical disk is inserted into the disk drive 1100. The serial port interface 1050 is connected with, for example, a mouse 1110 and a keyboard 1120. The video adapter 1060 is connected with, for example, a display 1130.

The hard disk drive 1090 stores, for example, an OS 1091, an application program 1092, a program module 1093, and program data 1094. That is, the program that defines each processing of the learning device 10 is mounted as the program module 1093 in which codes executable by a computer are described. The program module 1093 is stored in, for example, the hard disk drive 1090. For example, the program module 1093 for executing processing similar to the functional configuration in the learning device 10 is stored in the hard disk drive 1090. Note that the hard disk drive 1090 may be replaced with a solid state drive (SSD).

Moreover, the setting data to be used in the processing of the above-described embodiment is stored in, for example, the memory 1010 or the hard disk drive 1090 as the program data 1094. Then, the CPU 1020 reads out the program module 1093 and the program data 1094 stored in the memory 1010 and the hard disk drive 1090 to the RAM 1012 as necessary, and executes the processing of the above-described embodiment.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (a local area network (LAN), a wide area network (WAN), or the like). Then, the program module 1093 and the program data 1094 may be read by the CPU 1020 from another computer via the network interface 1070.

### REFERENCE SIGNS LIST

10 Learning device
11 Input/output unit
12 Storage unit
121 Model Information
13 Control unit
131 Generation unit
132 Transformation unit
133 Removal unit
134 Calculation unit
135 Update unit

1. A learning device comprising:
removal circuitry configured to remove a predetermined component from a frequency component obtained by transforming data of a predetermined domain;
calculation circuitry configured to calculate a loss function on a basis of a result obtained by inputting data obtained by returning the frequency component, from which the predetermined component has been removed by the removal circuitry, to the predetermined domain into a discriminator constituting an adversarial learning model; and
update circuitry configured to update a parameter of the adversarial learning model so that the loss function is optimized.

2. The learning device according to claim 1, wherein:
the removal circuitry removes a predetermined component from a first frequency component obtained by transforming first data and from a second frequency component obtained by transforming second data generated by a generator constituting the adversarial learning model,
the calculation circuitry calculates a loss function that becomes larger as discrimination accuracy of the discriminator becomes lower for each of data obtained by returning the first frequency component and the second frequency component, from which the predetermined component has been removed, to the predetermined domain, and
the update circuitry updates a parameter of the generator so that the loss function is optimized.

3. The learning device according to claim 2, wherein:
the removal circuitry removes a component whose distance from an origin in a frequency domain is equal to or longer than a threshold from the first frequency component obtained by transforming first image data in an RGB space and from the second frequency component obtained by transforming second image data in an RGB space generated by a generator constituting the adversarial learning model.

4. The learning device according to claim 2, wherein;
the calculation circuitry further calculates an inter-data error between the first frequency component and the second frequency component, and
the update unit updates a parameter of the adversarial learning model so that both the loss function and the inter-data error are optimized.

5. A learning method, comprising:
removing a predetermined component from a frequency component obtained by transforming data of a predetermined domain;
calculating a loss function on a basis of a result obtained by inputting data obtained by returning the frequency component, from which the predetermined component has been removed in the removal step, to the predetermined domain into a discriminator constituting an adversarial learning model; and
updating a parameter of the adversarial learning model so that the loss function is optimized.

6. A non-transitory computer readable medium storing a learning program for causing a computer to function as the learning device according to claim 1.

7. A non-transitory computer readable medium storing a program for causing a computer to perform the method of claim 5.
